(19) United States
(12) Patent Application Publication
(10) Pub. No.: US 2011/0037542 A1
(43) Pub. Date: Feb. 17, 2011

(54) Miniature Magnetic Switch Structures

(76) Inventors: William C. Page, Norcross, GA (US); Lawrence DiFrancesco, Colorado Springs, CO (US); Dain P. Bolling, Sebastian, FL (US); David P. Paturel, San Marino, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/607,865

(22) Filed: Oct. 28, 2009

Related U.S. Application Data
(60) Provisional application No. 61/233,073, filed on Aug. 11, 2009.

(51) Int. Cl. H01H 51/22

(52) U.S. Cl. 335/78

(57) ABSTRACT

A switching device structure comprising a top magnet, a bottom magnet, and a movable member disposed between the top and bottom magnets, the movable member having an electromagnet positioned thereon, the electromagnet comprising a plurality of laminated layers, the layers including a layer bearing an iron core and a number of armature layers which establish electrical conductor windings around the iron core.

### CROSS REFERENCE TO RELATED APPLICATIONS

This application claims the benefit of and priority to U.S. Provisional Application Ser. No. 61/233,073, filed Aug. 11, 2009, entitled, “Miniature Magnetic Switch Structures,” the contents of which is incorporated by reference herein in its entirety.

### FIELD

The subject disclosure pertains to the field of switching devices and relays and more particularly to miniature switching devices fabricated from a number of laminated layers.

### RELATED ART

Electromechanical and solid state switches and relays have long been known in the art. More recently, the art has focused on micro electromechanical systems (MEMS) technology.

### SUMMARY

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

According to an illustrative embodiment, a switching device structure is provided comprising a top magnet, a bottom magnet, and a movable member disposed between the top and bottom magnets. An electromagnet is positioned on the movable member.

In one embodiment, the electromagnet comprises a plurality of laminated layers, the layers including a layer bearing an iron core and a number of armature layers which establish electrical conductor windings around the iron core. The movable member further carries an electrical contact at one end positioned to close an electrical connection with a second electrical contact upon actuation of the electromagnet.

In one illustrative embodiment, the switching device structure further includes a first laminated layer located between the electromagnet and the top magnet comprising one or more posts of material suitable to channel magnetic forces from the top magnet toward the electromagnet, as well as a second laminated layer located between the electromagnet and the bottom magnet, the second laminated layer also comprising one or more posts of material suitable to channel magnetic forces from the bottom magnet toward the electromagnet.

### DESCRIPTION OF THE DRAWINGS

FIG. 1 is a side schematic side view of a switching device structure according to an illustrative embodiment;

FIG. 2 is a top schematic view of one embodiment of an array of switches constructed according to FIG. 1;

FIG. 3 is a side schematic side view illustrating the positioning of the layers of an illustrative embodiment of an armature assembly;

FIG. 4 illustrates three of the armature assembly layers in more detail;

FIG. 5 illustrates four more of the armature assembly layers in more detail;

FIG. 6 illustrates two more of the armature assembly layers in more detail;

FIG. 7 illustrates a top view of a plurality of electromagnet assemblies according to an illustrative embodiment;

FIG. 8 illustrates the final two layers of the armature assembly in more detail;

FIG. 9 is an enlarged view illustrating routing employed to create flexures or flappers according to the illustrative embodiment;

FIG. 10 illustrates the two ring frames of FIG. 1 in more detail;

FIG. 11 illustrates the top iron post layer of FIG. 1 in more detail;

FIG. 12 is a schematic side view illustrating the positioning of the layers of an illustrative base subassembly embodiment;

FIG. 13 is an enlarged view of the top layer of the base subassembly of FIG. 12;

FIG. 14 illustrates the bottom layer of the base subassembly of FIG. 12;

FIG. 15 illustrates four intermediate layers of the base subassembly of FIG. 12;

FIG. 16 illustrates the iron post layer of the base subassembly of FIG. 12.

### DETAILED DESCRIPTION OF ILLUSTRATIVE EMBODIMENTS

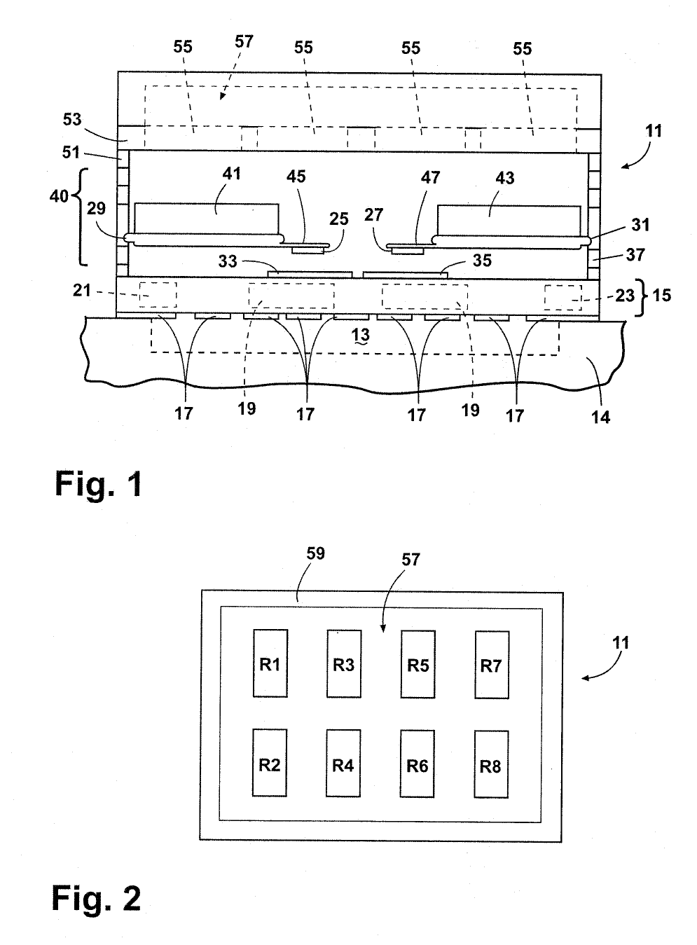

A TEMS switching device structure 11 according to an illustrative embodiment is shown schematically in FIG. 1. As shown in the top view of FIG. 2, the device 11 may include two rows of four switches or relays R₁, R₂, R₃, R₄, R₅, R₆, R₇, R₈, totaling eight switches in all. Various other layouts of varying numbers of switches or relays are of course possible, depending on the application.

The device structure 11 of the illustrative embodiment shown in FIG. 1 includes a bottom magnet 13 which resides in a well in a circuit card 14 to which the TEMS device 11 is mounted. Above the bottom magnet 13 is a base subassembly 15, which consists of a number of layers laminated together. The bottom most of these layers mounts electrical contacts 17, which connect the device 11 to electrical conductors on the circuit card 14. Another of the layers of the base subassembly 15 comprises a number of drilled out cylinders and two routed-out end strips, which are filled with an iron epoxy mix to form iron posts, e.g. 19, and iron strips 21, 23. These posts 19 and strips 21, 23 serve to channel the magnetic force of the bottom magnet 13 toward respective armature flappers 45, 47 and armature rear ends 29, 31.

The top layer of the base subassembly 15 carries respective electrically conductive flapper landing pads 33, 35. Above the base subassembly 15 is a first “ring frame” layer 37, which, in an illustrative embodiment, is a polyglass spacer with a rectangular cutout exposing each of the eight (8) switches R₁, R₂, R₃, R₄, R₅, R₆, R₇, R₈.

Above the first ring frame layer 37 is an armature subassembly 40, which may, for example, in an illustrative embodiment, comprise eleven (11) layers laminated together, as discussed in more detail below. The layers of the armature subassembly 40 are processed to form electromagnets, e.g. 41, 43 having iron cores with inner and outer conductive windings. The electromagnets 41, 43 are disposed on the respective flappers 45, 47, which carry respective electrical contacts 25, 27. A second ring frame spacer 51 is added on top of the armature subassembly 40.

An iron post layer 53 is applied on top of the second ring frame spacer 51. The post layer 53 comprises, for example, sixteen (16) iron epoxy-filled cylinders forming iron posts 55, which channel the magnetic force of a rectangular top magnet 57 to the respective armature flappers 45, 47 and front and rear end 29,31. The top magnet 57 may be mounted within a top magnet frame 59 (FIG. 2).

The top and bottom magnets 13, 57, may be, for example, Neodymium magnets formed of Neodymium alloy Nd₂ Fe₁₄ B, which is nickel plated for corrosion protection. NdFeB is a “hard” magnetic material, i.e., a permanent magnet. In one embodiment, the top magnet may be 375×420×90 mils, and the bottom magnet may be 255×415×110 mils.

In illustrative operation of the device 11, a positive pulse to the armature 41 pulls the armature flapper 45, down, creating an electrical connection or signal path between flapper contact 25 and the landing pad or contact 33. The contacts 25 and 33 are thereafter maintained in a “closed” state by the bottom magnet 13. Thereafter, a negative pulse to the armature 41 repels the flapper 45 away from the bottom magnet 13 and attracts it to the top magnet 57, which holds the flapper 45 in the open position after the negative pulse has passed. In one embodiment, the driver pulse may be, for example, 3 amps at 5 milliseconds.

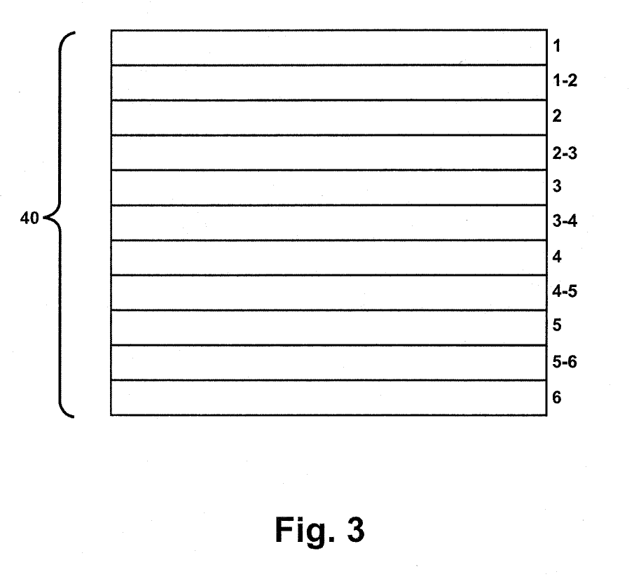

FIG. 3 illustrates the positioning of the eleven layers of an illustrative armature assembly 40. Each of these layers are, in general, formed of an insulator such as polyamide glass with, for example, copper, tin or other suitable electrical conductor materials. In one embodiment, polyamide glass substrates plated with copper layers may be patterned with photo resist and etched to create the desired contact and/or conductor patterns of the armature subassembly layers. Vias may be fabricated in the layers using known techniques.

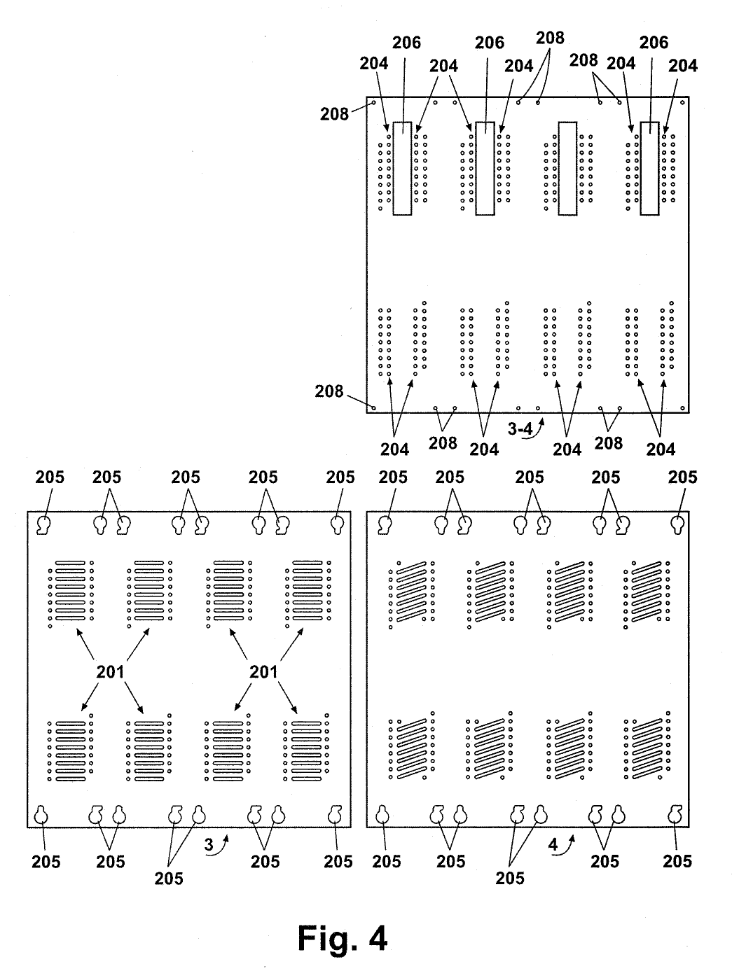

FIG. 4 illustrates three of the armature subassembly layers 3, 4 and 3-4. Layers 3 and 4 each include eight armature winding conductor patterns, 201, 203 formed on respective insulating substrates and eight vias 205 positioned along their respective top and bottom edges. As will be appreciated, one of the conductor patterns 201, 203 is associated with a respective one of the eight switches R₁, R₂, R₃, R₄, R₅, R₆, R₇, R₈, shown in FIG. 2.

Layer 3-4 of FIG. 4 is positioned between layers 3 and 4 and contains eight pairs of vias, e.g. 204, each positioned to appropriately connect with the armature winding conductor patterns 201, 203. Rectangular cavities 206 are routed out of layer 3-4 between the vias 204 and filled with material to form the cores of the armatures' electromagnets e.g. 41, 43. In the illustrative embodiment, an iron powder epoxy mix is used to form iron electromagnet cores. Vias, e.g. 208, are also established along the top and bottom edges of the layer 3-4 substrate. Then, layers 3 and 4 are laminated to opposite sides of layer 3-4 to form the inner winding of the armatures' electromagnets, e.g. 41, 43.

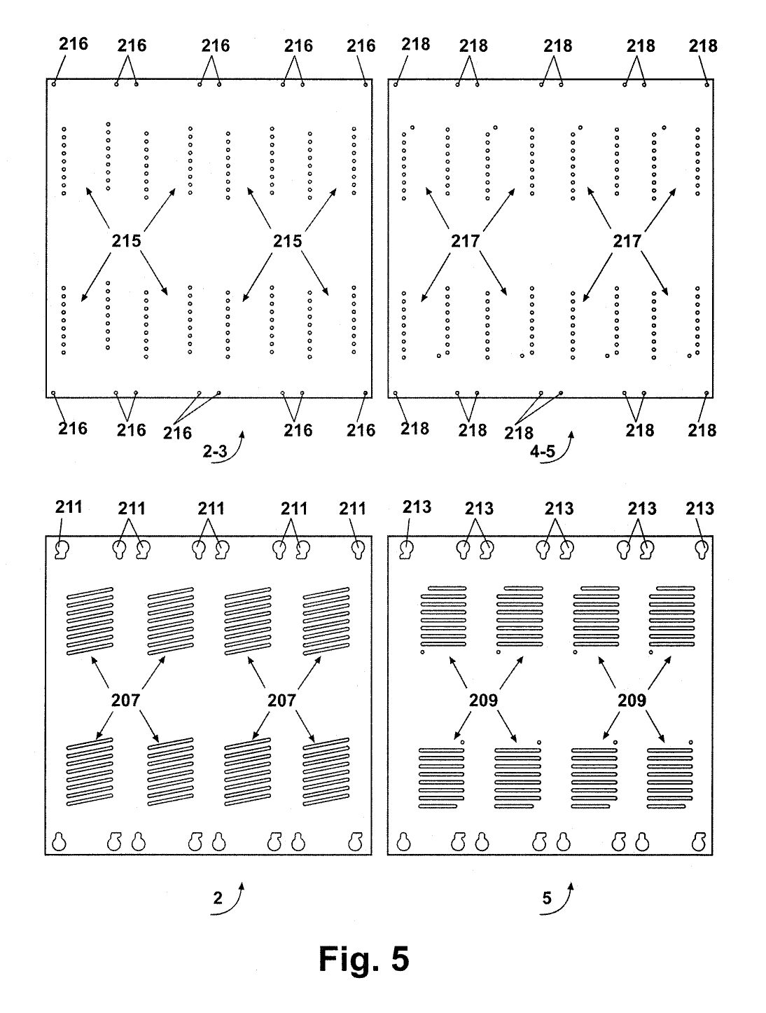

FIG. 5 illustrates four more of the armature layers: 2, 2-3, 4-5, and 5, Layers 2 and 5 each include eight armature winding conductor patterns 207, 209 and eight vias 211, 213 along their respective top and bottom edges. Layers 2-3 and 4-5 again contain eight respective via pairs 215, 217 positioned to appropriately connect and facilitate current flow through the armature winding conductor patterns 207, 209. Suitable vias, e.g. 216, 218 are established along the respective top and bottom edges of the layer 2-3 and 4-5 substrates.

To further construct the armature, the armature layer 2-3 is laminated to layer 3 of FIG. 4, and layer 4-5 is laminated to layer 4 of FIG. 4, thereby forming the connections for the armature outer windings. Next, layer 2 is laminated to layer 2-3 and layer 5 is laminated to layer 4-5 to complete the outer winding of the armatures' electromagnets, e.g. 41, 43.

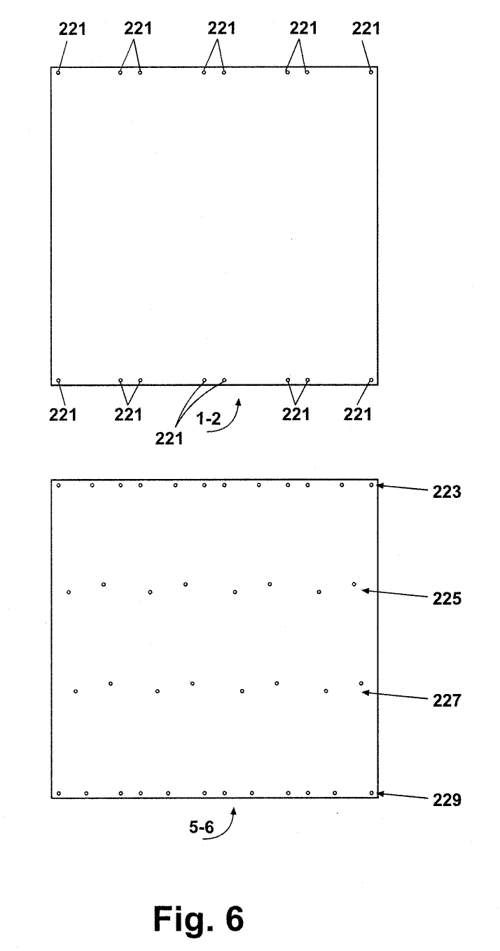

The next two layers, 1-2 and 5-6, of the armature subassembly 40 are illustrated in FIG. 6. Layer 1-2 has vias 221 on its respective top and bottom edges, while layer 5-6 has four rows of vias 223, 225, 227, 229 for establishing appropriate interconnections with layers on top and bottom of these respective layers 1-2, 5-6. The layer 5-6 center vias 225, 227 connect to the tip/ring pads of layer 6 while the edge vias 229, 229 connect to the armature coil up/down driver signal paths of layer 6. Layer 5-6 is laminated to layer 5, and layer 1-2 is laminated to layer 2.

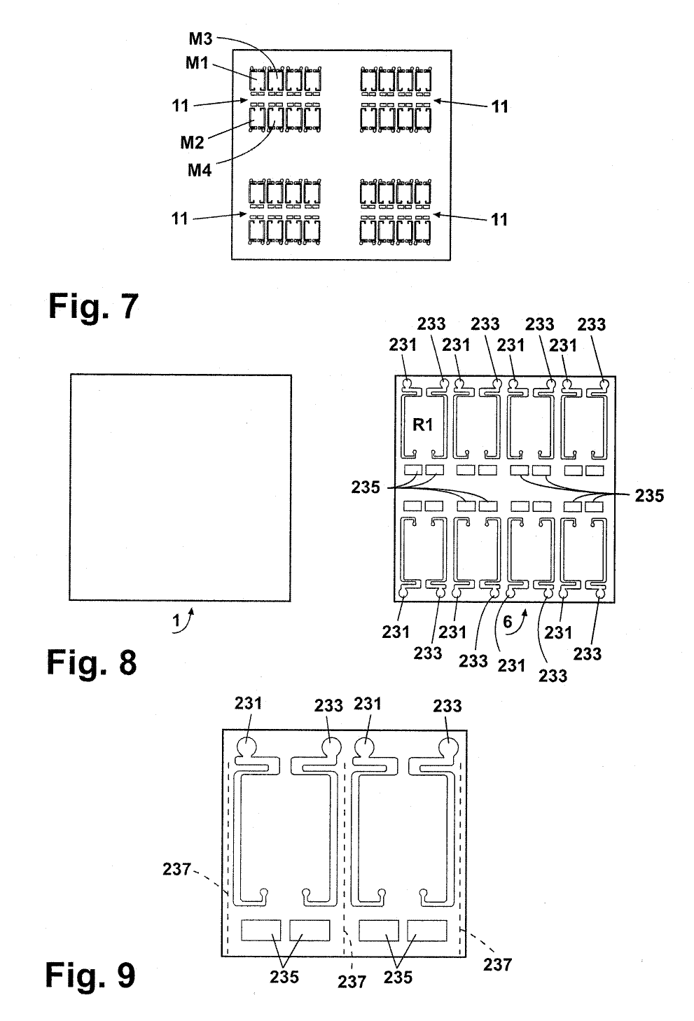

At this point in fabrication of the illustrative armature subassembly 40, the armature electromagnet assemblies are pre-routed, outlining individual electromagnets e.g. M1, M2, M3, M4, as shown in FIG. 7, each held together to the next within the panel by small tabs that are removed with final subsequent laser routing. FIG. 7 illustrates fabrication of four separate devices 11 on a common panel.

The final two layers 1, 6 of the armature subassembly 40 are shown in FIG. 8. After the pre-routing mentioned above, these layers 6, 1 are respectively laminated to layers 5-6 and 1-2 to complete the armature assembly. Layer 6 includes armature-in and armature-out conductors 231, 233 and flapper contact pads 235, which serve to short the tip and ring contacts, as discussed below. Layer 1 is simply a cover layer.

After the lamination of the last two layers 2, 6, the electrical contacts, e.g. 25, 27 are formed on the armature flappers. The contacts may be formed of various conductive materials, such as, for example, gold, nickel copper, or diamond particles. After contact formation, the armatures are laser routed to free the armatures for up and down movement held in place by their two flexures. Routing is done outside of the conductor lines as shown by dash 237 in FIG. 9. As a result, an armature coil is positioned within each of the flexure lines 237. After these steps, the armature subassembly is attached to the lower ring frame layer 37 by laminating layer 6 to the ring frame layer 37.

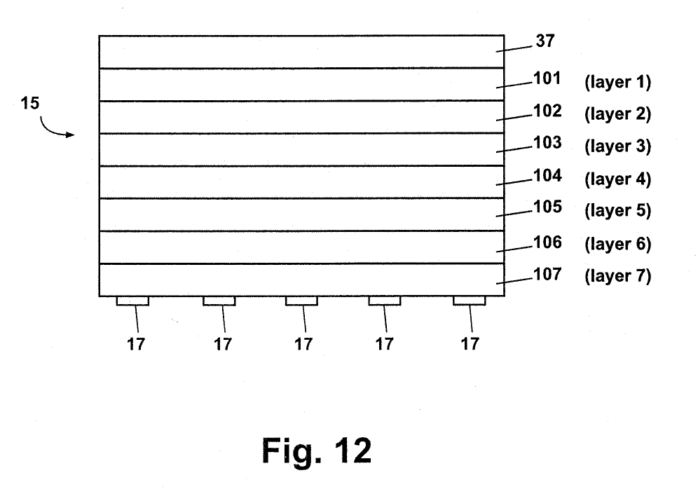

In one illustrative embodiment, the base subassembly 15 comprises a stack of layers 101, 102, 103, 104, 105, 106, and 107, laminated together, as shown schematically in FIG. 12. Lamination of the base subassembly 15 and other layers may be done by a suitable adhesive such as “Expandex” or other well-known methods.

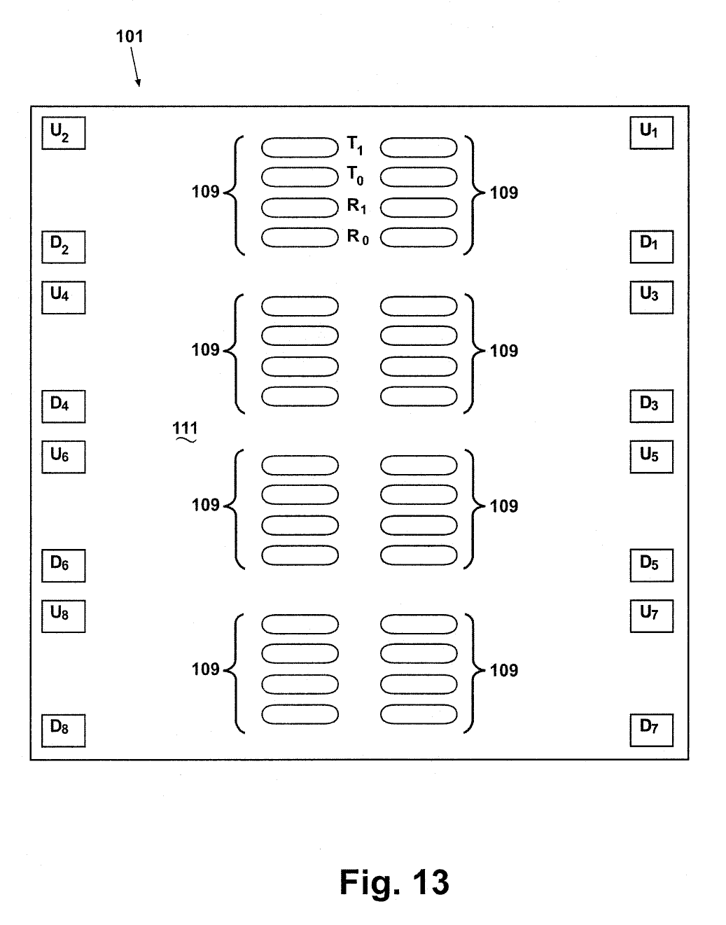

An illustrative top layer 101 of the base subassembly 15 of an individual 2×4 switch matrix as shown in FIG. 2 is illustrated in FIG. 13. This layer contains eight sets of four electrical contacts disposed in a central region 111 of the layer. In the illustrative embodiment, each set 109 contains a “tip-in” contact, and an adjacent “tip-out” contact, as well as a “ring-in” contact and an adjacent “ring-out” contact. For example, the first set 109 of four electrical contacts contains tip-in and tip-out contacts T₁ᵢ, T₁₀ and ring-in and ring-out contacts R₁₁, R₁₀. When a particular relay is activated, one of the flapper contact pads 235 shorts across the T₁, Tₒ contacts, while the adjacent flapper pad 235 shorts across the R₁ᵢ, R₁₀ contacts.

Along the top and bottom edges of the layer 101 are arranged conductor paths or “vias” through the layer for supplying drive pulses to the armature coils, e.g. 41, 43 formed above the layer 101. For example, “up” conductor U₁ supplies input current to the coil of a first armature coil, while “down” conductor D₁ conducts drive current out of the first armature coil. Similarly, U₃, D₃; U₅, D₅; U₇, D₇; U₈, D₂; U₄, D₄; U₆, D₆; and U₈, D₈ supply respective “up” and “down” currents to each of the respective seven other armature coils.

Top base subassembly layer 101 may be formed in one embodiment of an insulator such as polyamide glass with, for example, copper, tin or other suitable electrical conductor materials. Polyamide glass substrates plated with plated copper layers may be patterned with photo resist and etched to created the desired contact and/or conductor patterns of the base subassembly layers. The other layers of the device 11 may be similarly fabricated.

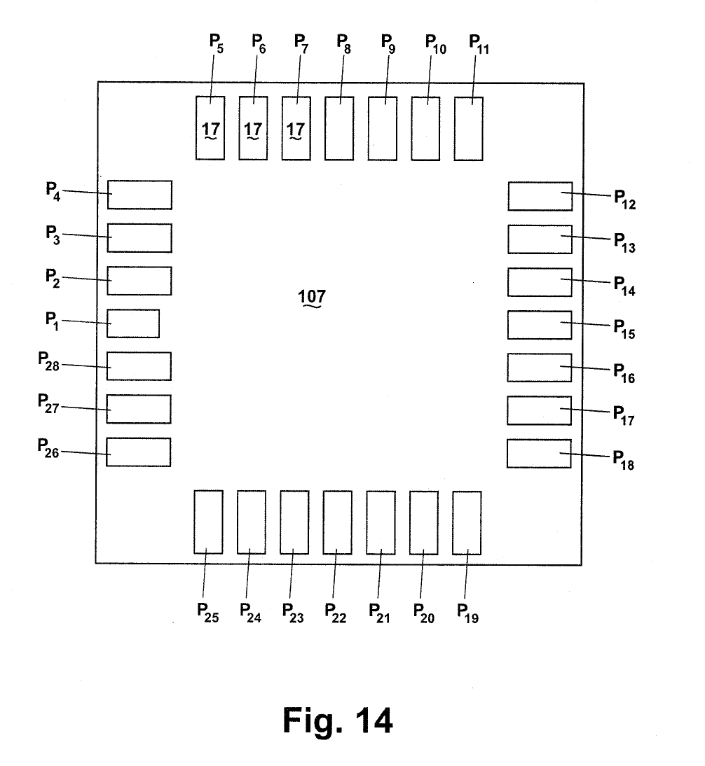

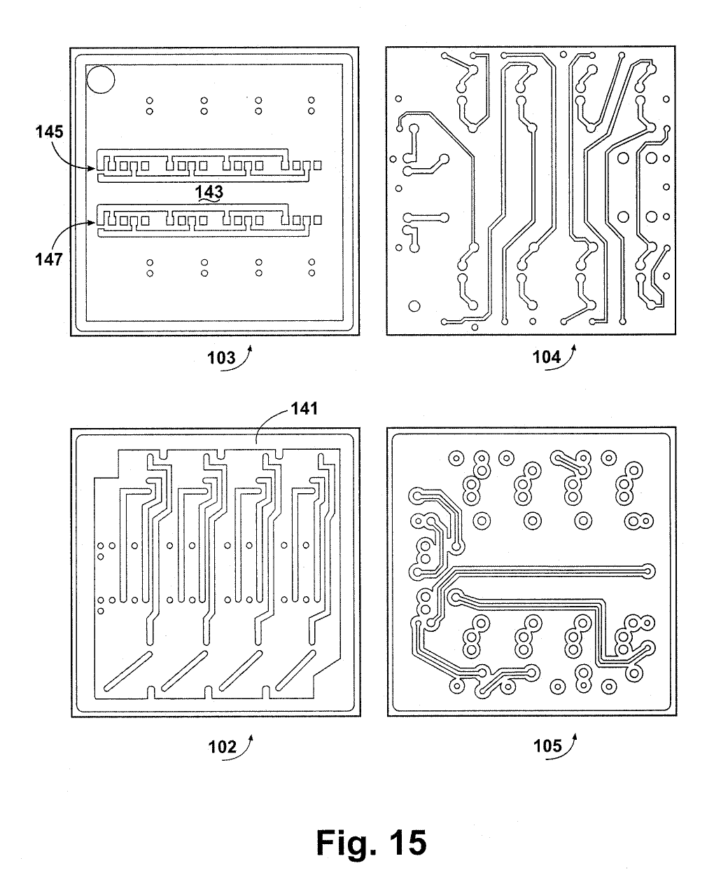

The remainder of the base subassembly 15 is concerned with routing signals from the tip and ring pads, e.g. Tₕ, T₁₀, R₁ᵢ, R₁ₒ, through the device to the exterior contacts 17 of the bottom base subassembly layer 107 and routing drive current to and from the armature supply conduits, U₁, D₁; U₂, D₂; U₃, D₃, etc. FIG. 14 illustrates the bottom bases subassembly layer 107 and the pin assignments of contacts 17 in more detail, to assist in illustrating the signal routing through the base subassembly 15 of the illustrative embodiment.

The pad assignments for the embodiment shown in FIG. 14 are as follows:

Pad Signals Assignments Table

| | |
|---|---|
| P₁ | C₀ Ring - in |
| P₂ | Common (coil control) |
| P₃ | Coil 1 Input |
| P₄ | C₀ Tip - in |
| P₅ | Tip - out O |
| P₆ | Ring - out O |
| P₇ | Coil 3 input |
| P₈ | Common |
| P₉ | Tip out 2 |
| P₁₀ | Coil 5 input |
| P₁₁ | Ring - out 2 |
| P₁₂ | Common |
| P₁₃ | Coil 7 input |
| P₁₄ | Common |
| P₁₅ | C1 Tip - in |
| P₁₆ | Common |
| P₁₇ | Coil 8 input |
| P₁₈ | C1 Ring - in |
| P₁₉ | Ring out 3 |
| P₂₀ | Tip - out 3 |
| P₂₁ | Coil 6 input |
| P₂₂ | Common |
| P₂₃ | Ring - out 1 |
| P₂₄ | Coil 4 input |
| P₂₅ | Tip out 1 |
| P₂₆ | Common |
| P₂₇ | Coil 2 input |
| P₂₈ | Common |

It will be appreciated from the pin assignments that all of the “down” armature coil supply conduits D₁, D₂, D₃, D₄, D₅, D₆, D₇, D₈ are connected in common. In this connection, the layer 102 includes a metallization border 141 forming a common ground plane for the armatures. Layer 3 shows a post which connects the common plane to pin 2. Layer 105 includes traces and vias to the pin outs on layer 7.

Additionally, it will be seen from the pin assignments that there is one pair of tip and ring conductor outputs for relays R₁ and R₂, one pair for R₃ and R₄, one pair for R₅ and R₆, and one pair for R₇ and R₈ There are also two pairs of tip and ring inputs (C₀ Ring-in, C₀ Tip-in, C1 Tip-in, C1 Ring-in). Thus, in the illustrative embodiment, only two of the relays of the 2×4 matrix (one odd, one even) may be closed at the same time. The metallization pattern of layer 103 reflects this tip and ring interconnection scheme. In particular, the central metallization 143 comprises two rows 145, 147 wherein the top row provides tip and ring interconnections for the row “1” tip and ring inputs and the bottom row provides the tip and ring interconnections for the row “2” tip and ring inputs, thus illustrating how the tips and rings are connected in common. The manner of interconnection is such that connecting opposite row 1 and row 2 switches, e.g. R₁ and R₂ in FIG. 2, creates a short. In one illustrative embodiment, software control prevents such shorts.

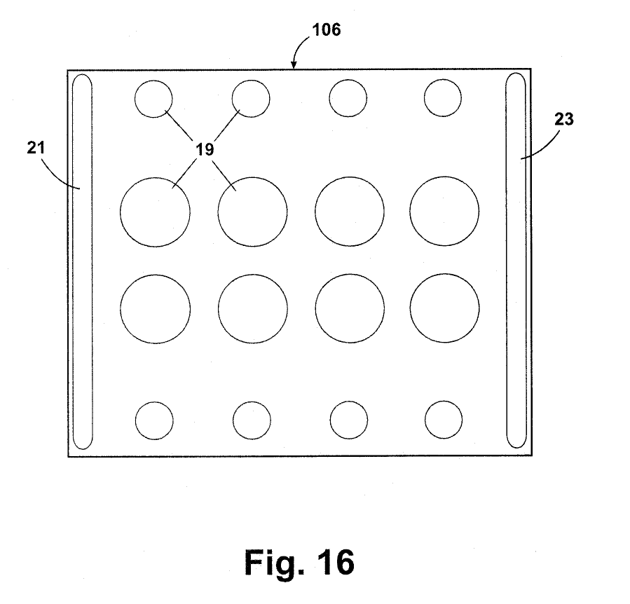

The iron post layer 106 of the base subassembly is further illustrated in FIG. 16. As shown, eight large and eight small cylinders are drilled and two end strips are routed out of layer 106 and are filled with an iron powder epoxy mix to form the iron posts 19 and iron strips 21, 23 that channel the magnetic force of the bottom magnet 13 toward the armatures' flappers 25, 27 and the armature rear ends 29, 31. Suitable vias (not shown) are formed in layer 106 to transmit signals between the layers 105 and 107. Thereafter, the layer 106 is laminated between layers 105 and 107 to complete the base subassembly. In one embodiment, layer 106 may be, for example, 16 mils thick, while the large and small cylinders are 64 mils and 30 mils in diameter respectively. Layers 102, 103, 104, 105 may be, for example, 2 to 3 mils thick. The lower ring frame layer 37 is laminated to the first base subassembly layer 101.

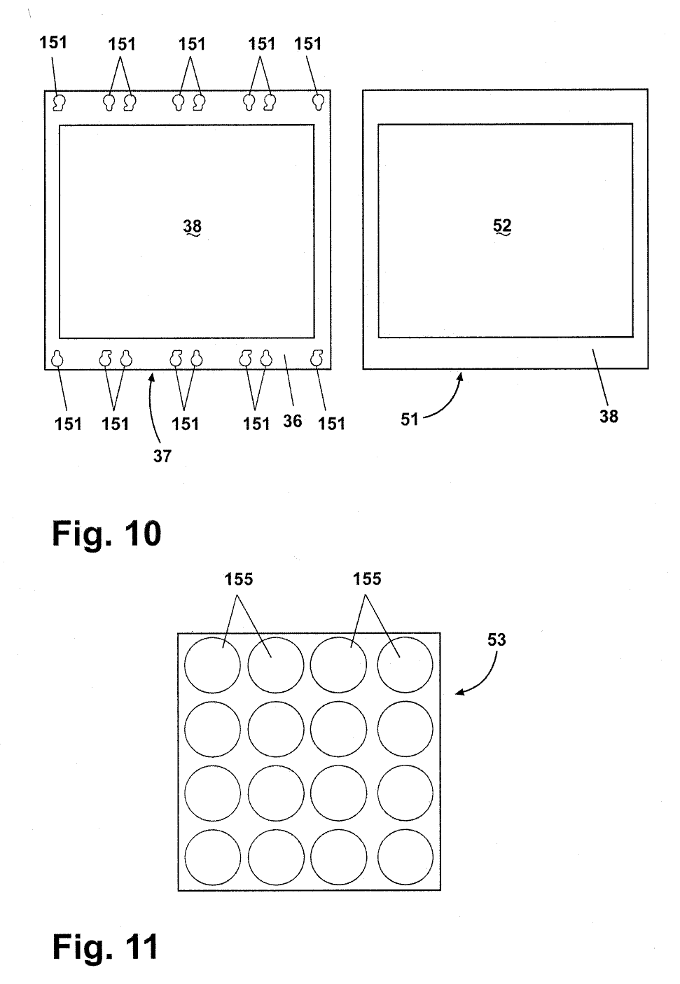

The upper and lower ring frames 37, 51 are further illustrated in FIG. 10. In one embodiment, they are 8 and 5 mils thick respectively. The lower ring frame 37 has appropriate vias 151 for conducting the armature drive signals, while the upper ring frame 51 has no vias. The rectangular space 38, 52, within each of the borders 36, 38 of the respective frames 37, 51 are hollow.

The upper iron post layer 53 is illustrated further detail in FIG. 11. It comprises 16 small cylinders, e.g. 155, drilled and filled with an iron powder epoxy mix to form iron posts that channel the magnetic force of the top magnet 55 toward the armature subassembly 40.

Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

1-4. (canceled)

5. In a switching device or relay, the structure comprising:
a plurality of structural layers laminated together; and
a three dimensional conductive coil formed within the laminated layers.

6. The structure of claim 5 wherein each of said structural layers comprises a planar slice of said three dimensional conductive coil.

7. The structure of claim 6 wherein said structural layers further comprise a first layer wherein first and second rows of adjacent vias are formed in non-conductive portions of the first layer.

8. The structure of claim 7 wherein said structural layers further comprise a second layer and a third layer, each comprising conductor portions which interconnect said vias on respective top and bottom sides of said first layer so as to complete said three dimensional coil.

9. The structure of claim 5 wherein said layers comprise a plurality of layers, each layer including first and second rows of vias, the vias of one layer disposed to interconnect conductively with respective vias of an adjacent layer so as to form a portion of said conductive coil.

10. The structure of claim 9 wherein said structural layers further comprise a top layer and a bottom layer, each comprising conductor portions which interconnect said vias on respective top and bottom sides of said plurality of layers so as to complete said three dimensional coil.

11. The structure of claim 1 further comprising a base structure formed of laminated layers beneath said coil and having conductive paths formed therethrough and connected to supply drive current to said coil.

12. In a switching device or relay, the structure comprising:
a plurality of structural layers laminated together; and
a conductive coil formed within the laminated layers.

13. A switching device or relay comprising:
a cavity formed by a plurality of laminated layers and having first and second oppositely disposed interior walls;
four movable members extending adjacent one another into said cavity from the first interior wall;
four movable members extending adjacent one another into said cavity from the second interior wall; and
a three dimensional conductive coil formed in a plurality of laminated layers on each of said moveable members.
